(19) United States
(12) Patent Application Publication
(10) Pub. No.: US 2018/0047496 A1
(43) Pub. Date: Feb. 15, 2018

(54) CURRENT CONDUCTOR STRUCTURE WITH FREQUENCY-DEPENDENT RESISTANCE

(71) Applicant: ABB Technology Oy, Helsinki (FI)

(72) Inventors: Mika Masti, Tampere (FI); Henri Kinnunen, Veikkola (FI); Matti Laitinen, Kirkkonummi (FI)

(21) Appl. No.: 15/677,632

(22) Filed: Aug. 15, 2017

(30) Foreign Application Priority Data
Aug. 15, 2016 (EP) 16184177.0

(51) Int. Cl. H01F 27/28; H01F 41/063

(52) U.S. Cl. CPC H01F 27/2847; H01F 41/063

(57) ABSTRACT

A current conductor structure with a frequency-dependent resistance. The current conductor structure comprises a first current conductor and a second current conductor connected in parallel. The first and second current conductor are configured such that the second current conductor has a higher resistance and a lower inductance than the first conductor so that, above a set frequency limit, the resistance component of a total impedance of the current conductor structure is larger than the resistance component of the impedance of the first conductor current.

### FIELD

The present disclosure relates to high-frequency electrical emissions and particularly to damping of such emissions in a power converter.

### BACKGROUND

Rated powers of power electronics converters may range from several hundreds of watts to megawatts, for example. This power may be transmitted at frequencies that are in the range of few Hertz to hundreds of Hertz. Power electronics converters may use hard-switched semiconductors for switching of currents and voltages. Because of this, the semiconductors may be a source of a wide bandwidth of voltages and currents at frequencies other that those used for transmitting the power. The electromagnetic energy in these high-frequency currents and voltages may be small in comparison to the rated power of the converter, but the currents and voltages may still be harmful to the electrical environment or to the converter itself. In a frequency converter, for example, oscillating high-frequency currents may cause additional losses in components of the converter, and high-frequency voltages may induce additional stress to the components and age them prematurely, especially in commutation circuits of switching components of the frequency converter.

In EMC standards covering frequency converters, emissions may be categorized into conductive and radiated emissions. The EMC standards may place limits for conductive emissions in a set frequency range, e.g. from 150 kHz to 30 MHz. Similarly, limits may be placed for radiated emission frequencies in a set range, e.g. from 30 MHz to 1 GHz. Harmful high-frequency content produced by a frequency converter may be in the form of conducted and radiated emissions.

In general, there are two basic approaches for mitigating high-frequency emissions: decreasing the amplitude of high-frequency components at the source and preventing high-frequency emissions from entering the environment by conducting them to components or structures in which they are dissipated into power losses.

The methods for mitigating effects of fast switching in a converter are similar. The rate of change of the voltages and currents may be decreased by slowing down the switching components. Alternatively, or in addition, oscillating high-frequency currents may be dampened with resistance components.

The switching components of a frequency converter may have the highest impact on power losses of the converter. Thus, slowing them down may induce high additional power losses thereby having a significant negative effect on a total efficiency of the converter. Further, even with a dedicated gate control of active switches such as IGBTs, frequency content of the additional losses may not be selectively controllable. For example, the turn-on speed of a modern IGBT may be controlled fairly well at a given operating point defined by a given voltage, current and temperature, but the switching speed may be different at a different operating point. Furthermore, the rate of change of the voltage at a turn-off may be directly set by the design and operating point of the IGBT device, and thus, may not be controllable.

Both parallel and serial filtering may be used for damping the oscillating currents. The filtering is typically implemented as filtering circuits made of passive components, such as inductors, capacitors and resistors. These components may increase the cost and size of the converter. Further, in the case of a serial filtering, for example, both an inductance and a resistance may have negative effects to the efficiency of the power flow at fundamental frequency because of voltage drops and losses in conductors and cores of magnetic components. Placing resistors to the commutation circuits may also increase the inductance of the circuits which, in turn, may induce higher overvoltage spikes that may stress components inside, as well as outside the converter.

### BRIEF DESCRIPTION

An object of the present disclosure is to provide a current conductor structure so as to alleviate the above disadvantages. The objects of the invention are achieved by a current conductor structure and a method for manufacturing the same, which are characterized by what is stated in the independent claims. The preferred embodiments of the invention are disclosed in the dependent claims.

In order to dampen undesired high-frequency emissions, a current conductor structure with two or more parallel current paths may be used. Each current route may have differing loop inductance and resistance values specifically selected to cause a higher resistance level at high frequencies.

The parallel current paths of a current conductor structure according to the present disclosure may be implemented as loop structures. The current conductor structure may be in the form of a laminate structure made of layers of insulating materials. The current paths may be in the form of thin strips of electrically conducting material running between and on top of the layers. The thin strips may be implemented as strips of metal foil, for example. Different materials may be used for each conductor. This enables formulation of current conductor structures with a wide range of desired resistances and limit frequencies. A current conductor structure according to the present disclosure can be integrated to the main current or commutation loops with a minimal negative effect to the power losses at the lower frequencies used for transferring power. Current conductor structures according to the present disclosure may also be used for selective parallel filtering.

With a current conductor structure according to the present disclosure, frequency-dependent losses may be added to a current path in order to dampen oscillations in the frequency ranges of conductive and radiated emissions (as well as in a frequency range of bearing currents, for example) without increasing the number of passive components in the current path. Frequency-dependant resistance may be added to the main circuit and commutation path without increasing inductance. A current conductor structure according to the present disclosure may be integrated to various places of the main circuit, e.g. the DC-bus, the commutation circuit, input and output bus. Thus, the structure may be used to distribute additional HF-damping throughout the main circuit. The current conductor structure may also be used as a part of parallel filtering instead using of separate passive components.

### BRIEF DESCRIPTION OF THE DRAWINGS

In the following the invention will be described in greater detail by means of preferred embodiments with reference to the accompanying drawings, in which

FIG. 1 shows an exemplary schematic of a current conductor structure according to the present disclosure;

FIGS. 2a and 2b show exemplary, simplified diagrams of impedances of parallel current paths as functions of frequency;

FIGS. 3a to 3c show simplified examples of embodiments of the current conductor structure according to the present disclosure; and

FIGS. 4a and 4b show exemplary, simplified diagrams of impedances of parallel current paths implemented as thin conductor foils in a laminate structure.

### DETAILED DESCRIPTION

The present disclosure describes a current conductor structure with a frequency-dependent resistance. The current conductor structure may be in the form of a bus bar in a main circuit of a power electronics converter, for example. The power electronic converter, may be a frequency converter, for example.

The current conductor structure may comprise at least a first current path and a second current path connected in parallel. The first and second current path may be configured such that the second current path has a higher resistance and a lower inductance than the first current path. As a result, the resistance component of a total impedance of the current conductor structure is larger than the resistance component of the impedance of the first current path at frequencies above a set frequency limit. A current through a resistance dissipates power into heat. Therefore, the current conductor structure selectively dampens currents at frequencies above the set frequency limit through dissipation. The current conductor structure may be used in various places in power electronics devices. For example, the current conductor structure may be integrated to a main current or commutation loops of a power converter with minimal effect in the losses at those frequencies transferring the power. The current conductor structure may also be used for selective parallel filtering. The adjustable high-frequency damping provided by the current conductor structure may be integrated to a main circuit of a converter without a significant effect to losses at lower frequencies.

FIG. 1 shows an exemplary schematic of a current conductor structure according to the present disclosure. In FIG. 1, a current conductor structure 10 comprises a first current path and a second current path connected in parallel. The first current path is represented by a first impedance Z₁, and the second current path is represented by a second impedance Z₂. Together the first impedance Z₁ and the second impedance Z₂ form a total impedance Zₜₒₜ of the current conductor structure 10.

The impedances Z₁ and Z₂ each consist of two components: a resistance component R (i.e. resistance) and a reactive component X (i.e. reactance). These components have a 90 degree phase shift between each other. The reactance in the current conductor structure according to the present disclosure is inductive, so the reactance leads the resistance. Such impedance may be defined as a complex number as follows, for example:

Z=R+jX=R+jωL, (1)

where ωL represents the amplitude of the reactive component. L represents the inductance of the current path and represents ω angular frequency.

The reactive component changes in response to frequency, whereas the resistance component ideally remains unchanged. At low frequencies where reactances of the current paths are low, a first impedance Z₁ of the first current path is lower than a second impedance Z₂ of the second current path because the second current path has a higher resistance. However, as the frequency ω increases, a reactance X₁ of the first current path rises faster than a reactance X₂ of the second current path because the first current path has a higher inductance. Thus, at a set limit frequency, the amplitude |Z₁| of the first impedance Z₁ reaches (and then surpasses) the amplitude |Z₂| of the second impedance Z₂.

Based on the impedances Z₁ and Z₂ of the first and second current path, the total impedance Zₜₒₜ may be calculated as follows, for example:

$${Z}_{tot} = \frac{{Z}_{1} {Z}_{2}}{{Z}_{1} + {Z}_{2}} . \qquad ( 2 )$$

The quality factor (i.e. the reactance-to-resistance ratio) of the total impedance Zₜₒₜ calculated with Equation (2) is between the quality factors of the impedances of the first and second current path. The first and second current path may be configured such that, at low frequencies, the first impedance Z₁ is much lower than the second impedance Z₂. As a result, the divisor in Equation (2) is determined by the second impedance Z₂, and the result of the division is closer to the first impedance. However, at higher frequencies above the set limit frequency, the first impedance Z₁ is higher than the second impedance Z₂, and the result of Equation (2) is closer to the second impedance Z₂.

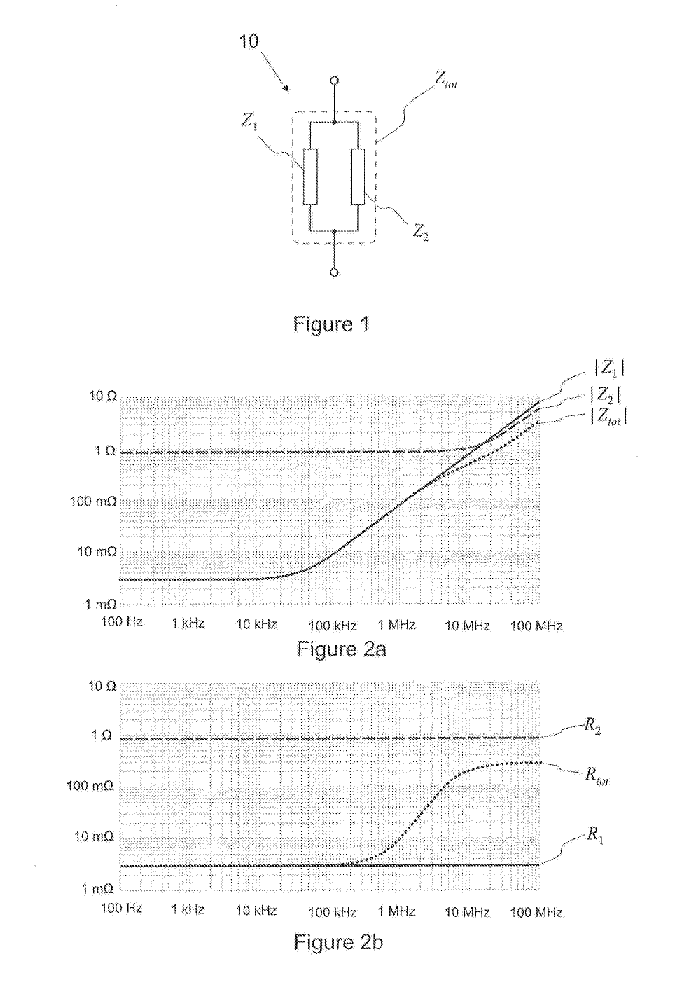

FIGS. 2a and 2b show exemplary, simplified diagrams of impedances of parallel current paths as functions of frequency. In FIG. 2a, amplitudes |Z₁|, |Z₂|, and |Zₜₒₜ| of impedances Z₁, Z₂ and Zₜₒₜ are shown in a logarithmic scale. The first impedance Z₁ of the first current path is represented by a solid line, the second impedance Z₂ of the second current path is represented by a dashed line, and the total impedance Zₜₒₜ of the parallel connection of the two current connectors is represented by a dotted line. In FIG. 2b, respective resistance components R₁, R₂ and Rₜₒₜ of the impedances Z₁, Z₂ and Zₜₒₜ are shown as function of frequency with corresponding line patterns. In FIGS. 2a and 2b, the first current path has a smaller resistance but a higher inductance than the second current path. The first path has a first resistance R₁ of 3 mΩ and a first inductance L₁ of 12.4 nH, whereas the second path has a second resistance R₂ of 0.85Ω and a second inductance L₂ of 9.14 nH.

At lower frequencies in FIGS. 2a and 2b, the amplitude of the first impedance Z₁ is lower than the amplitude of the second impedance Z₂ and, thus, the first impedance determines the characteristics of the total impedance Zₜₒₜ. The resistance component Rₜₒₜ of the total impedance Zₜₒₜ remains close to the resistance component R₁ of the first impedance Z₁. However, as the frequency increases in FIGS. 2a and 2b, the first impedance reaches the second impedance Z₂ at a limit frequency between 10 MHz and 20 MHz, and then exceeds the second impedance Z₂. As a result, the amplitude of the first impedance Z₁ is lower than the amplitude of the second impedance Z₂. Thus, the second impedance Z₂ now determines the characteristics of the total impedance Zₜₒₜ, and the resistance component Rₜₒₜ of the total impedance Zₜₒₜ rises to close to the resistance component R₂ of the second impedance Z₂.

The frequency at which the second current path becomes dominant (i.e. the second current path has an impedance with a lower amplitude than the first current path) can be controlled through the selection of resistances and inductances of the first and second current path. It is thus possible to set a limit frequency at which dissipative power losses (caused by the resistance component of the total impedance) increase. The limit may represent a frequency above which undesirable emissions and oscillations are to be damped, for example.

A current conductor structure according to the present disclosure may be implemented such that the first and second current path are implemented as electrically conducting strips on a supporting laminate structure.

For example, a current conductor structure according to the present disclosure may comprise one or more layers of insulating material forming a supporting laminate structure, and a first electrically conducting strip acting as the first current path. The first electrically conducting strip may be arranged to form a first inductive loop that extends in a first direction parallel to the plane of the laminate structure and in a second direction perpendicular to the plane of the laminate structure. The current conductor structure may further comprise a second electrically conducting strip which acts as the second current path, wherein the second electrically conducting strip is arranged to form a second inductive loop that extends in the first and second direction. The dimensions of the first and second inductive loop in the first and second direction define loop areas of the first and second inductive loop. The dimensions may be selected such that the loop area of the first inductive loop is larger than the loop area of the second inductive loop.

With a laminate structure, the current conductor structure may be easily integrated to a DC busbar of a power converter in order to achieve extra high frequency resistance in commutation loop noise reduction, for example. An additional benefit of a current conductor structure according to the present disclosure is a lowered inductance on higher frequencies, which lowers peak voltage levels in the main circuit commutation loops of the power converter.

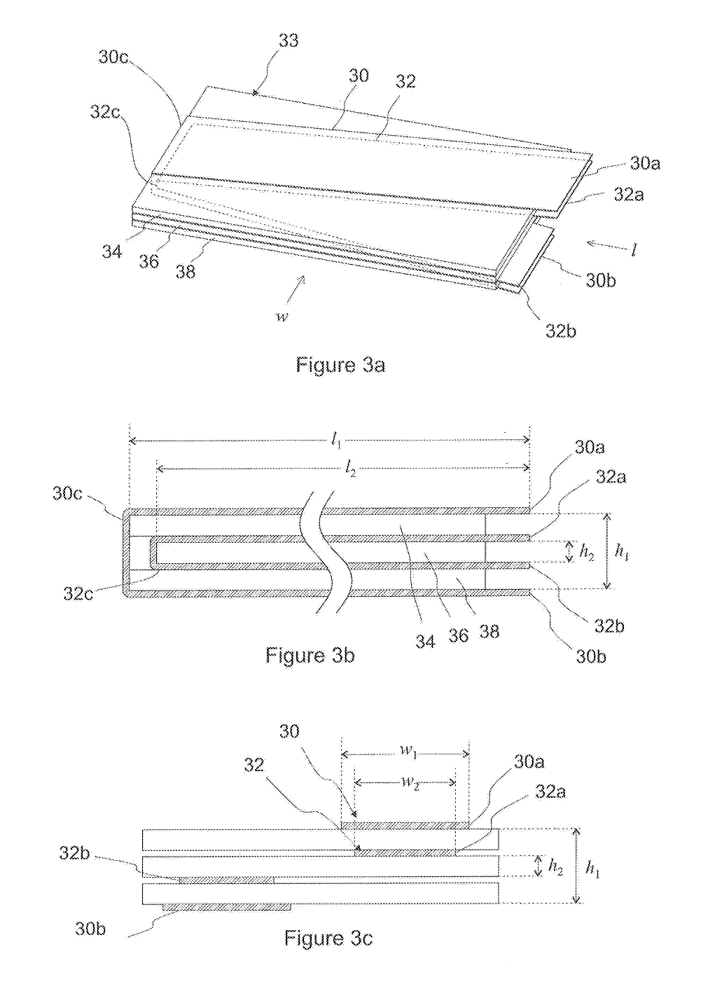

FIGS. 3a to 3b show simplified examples of embodiments of the current conductor structure according to the present disclosure. In FIG. 3a, a perspective view of the current conductor structure is shown. The current conductor structure comprises a first electrically conducting strip 30 (which acts as the first current path) and a second electrically conducting strip 32 (which acts as the second current path) on a supporting laminate structure 33 comprising a plurality of layers. FIG. 3a also shows two perpendicular axes w and l. The widths of the laminate structure 33 and its layers may be defined along axis w while the lengths of the laminate structure 33 and its layers may be defined along axis l. Together, the axes w and l define the plane of the laminate structure 33. FIG. 3b shows a simplified cross section perpendicular to the width axis w. FIG. 3c shows a simplified cross section perpendicular to the length axis l.

The laminate structure 33 in FIGS. 3a to 3c comprises three layers 34, 36, and 38. Each of the layers 34, 36, and 38 may be made of an insulating material. The layers may be made of the same material, or different materials. The layers may have the same thickness or different thicknesses.

The first conducting strip 30 and the second conducting strip 32 both have their first ends 30a and 32a, respectively, on a first end of the laminate structure 33. The first conducting strip 30 and the second conducting strip 32 extend parallel to the length axis l (i.e. in the first direction) towards a second end of the laminate structure 33. At the second end, the first conducting strip 30 and the second conducting strip 32 form folds 30c and 32c, respectively. At the folds, the conducting strips extend in a direction of the thickness h of the laminate structure 33 (i.e. in the second direction perpendicular to the plane of the laminate structure). After folding, the first conducting strip 30 and the second conducting strip 32 extend back to the first end of the laminate structure 33, ending finally at second ends 30b and 32b, respectively. The portions of the conducting strips 30 and 32 before folding may extend on different planes (that are parallel to the plane of the laminate structure) than the portions after folding. In this manner, the first conducting strip 30 and the second conducting strip 32 form a first and second inductive loop, respectively. FIGS. 3a and 3c show that the first ends 30a and 32a and the second ends 30b and 32b have a distance between each other along the width axis w. This increases the loop areas of the first and second inductive loop.

Although not shown in FIGS. 3a to 3c the first conducting strip 30 and the second conducting strip 32 are connected in parallel. The first end 30a of the first conducting strip 30 may be connected to the first end 32a of the second conducting strip 32, and the second end 30b of the first conducting strip 30 may be connected to the second end 32b of the second conducting strip 32. A galvanic connection between the ends may be produced by crimping, welding or soldering, for example.

In a current conductor structure according to the present disclosure, the second current path (e.g. the second conducting strip 32 in FIGS. 3a to 3c) has a lower inductance than the first path (e.g. the first conducting strip 30 in FIGS. 3a to 3c). The inductance of a current path is responsive to the loop area formed by the path. A difference in the loop area may be achieved in many ways. For example, if the second electrically conducting strip wraps around one or more layers of the supporting laminate structure to form the second inductive loop, the first electrically conducting strip may wrap around at least one more layer of the supporting laminate structure than the first electrically conducting strip to form the first inductive loop. The area of the inductive loops may also be controlled by controlling the thicknesses of the layers of the laminate structure. Alternatively, or in addition, the second conducting strip may extend less in the first direction. This also reduces the loop area.

The loop area of the first inductive loop is larger than the loop area of the second inductive loop in FIGS. 3a to 3c. The second inductive loop is arranged inside the first inductive loop, so that a height h₁ of the second loop (in the direction perpendicular to the plane of the laminate structure 33) is higher than a height h₂ of the second loop. Further, a length l₁ of the first inductive loop (in the direction of the length axis l) is longer than a length l₂ of the second inductive loop.

According to the present disclosure, the second current path (e.g. the second conducting strip 32 in FIGS. 3a to 3c) has a higher resistance than the first path (e.g. the first conducting strip 30 in FIGS. 3a to 3c). The resistance of the paths may be controlled in various ways. For example, the second electrically conducting strip may be made from a different material than the first electrically conducting strip. The first current path may be made of copper foil and the second current path may be made of aluminium foil, for example. Alternatively, or in addition, the second electrically conducting strip may have a different width and/or thickness than the first electrically conducting strip. In the cross-section shown in FIG. 3c, a width w₁ of the first electrically conducting strip 30 is larger than a width w₂ of the second electrically conducting strip 32. Adjusting the width of the electrically conducting strips and/or the position of the ends of the strip may also have an effect to the inductance of the respective inductive loop. For example, making a strip wider may decrease the inductance the loop formed by the strip because the loop area may become smaller. The inductance of an inductive loop formed by a conductive strip according to the present disclosure may be adjusted by controlling the distance between the first end and the second end of the strip. Thus there are many different means to optimize the resistive and inductive component of the loop.

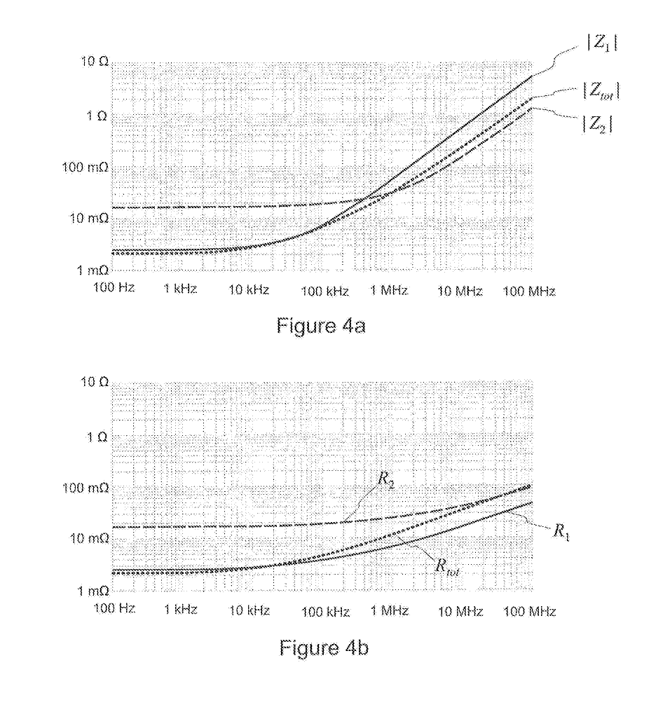

If thin conductor foils are used in the current conductor structure, the skin effect associated with eddy currents may be kept at minimum. FIGS. 4a and 4b show exemplary, simplified diagrams of impedances of parallel current paths implemented as thin conductor foils in a laminate structure. In FIG. 4a, amplitudes of impedances Z₁, Z₂, and Zₜₒₜ are shown. The first impedance Z₁ of the first current path is represented by a solid line, the second impedance Z₂ of the second current path is represented by a dashed line, and the total impedance Zₜₒₜ of the parallel connection of the two current connectors is represented by a dotted line. In FIG. 4b, respective resistance components R₁, R₂, and Rₜₒₜ of the impedances Z₁, Z₂, and Zₜₒₜ are shown as function of frequency with corresponding line patterns. In FIGS. 4a and 4b, the first current path has a smaller resistance but a higher inductance than the second current path. The skin effect is clearly visible in FIG. 4b. It causes the resistances R₁ and R₂ to increase responsive to the frequency. However, it is also clearly visible that current conductor structure according to the present disclosure structure increases the total resistance component Rₜₒₜ in high frequencies more than the skin-effect alone.

The impedance characteristics of a current conductor structure according to the present disclosure may be adjusted with passive electric components. The first and/or the second current path may comprise a passive component. For example, a passive component may be connected in parallel with the first current conducting strip and/or in parallel with the second current conducting strip. In FIGS. 3a and 3b, for example, a passive component may have been connected in parallel with the first conducting strip 30 at the fold 30c of the first conducting strip 30. It is also possible to connect a passive component between the first conducting strip and the second conducting strip in order to adjust the impedance characteristics of the current conductor structure.

Also, instead of using continuous conducting strips for forming the first and second current paths according to the present disclosure, the conducting strips may each comprise separate portions connected by an electric component. For example, similar to the embodiments of FIGS. 3a to 3c, the current conductor structure may comprise one or more layers of insulating material forming a supporting laminate structure. However, the current conductor structure may comprise a first portion and a second portion of a first electrically conducting strip instead of a continuous first electrically conducting strip. The current conductor structure may comprise a first passive electric component electrically coupling the first and second portion together. In FIGS. 3a and 3b, for example, the current conductor structure may comprise passive electric component instead of fold 30c. The first portion and the second portion may be arranged to extend on different planes that are parallel to the plane of the laminate structure. The first portion, the second portion, and the first passive electric component may be arranged to act as the first current path and form a first inductive loop that extends in a first direction parallel the plane of the laminate structure and in a second direction perpendicular to the plane of the laminate structure. Further, similar to the first electrically conducting strip, the current conductor structure may comprise a first portion and a second portion of a second electrically conducting strip, and a second passive electric component electrically coupling the first and second portion of the second electrically conducting strip together. The first portion and the second portion of the second electrically conducting strip may be arranged to extend on different planes that are parallel to the plane of the laminate structure. The first portion, the second portion, and the passive electric component may be arranged to act as the second current path and form a second inductive loop that extends in the first direction and in the second direction.

The passive electric components may be resistors or capacitors for example. By selecting suitable component values, the impedances of the first and second current path may be adjusted. In addition to using passive component dedicated solely for the current conductor structure, passive components having other functions may also utilized. For example, a capacitor of a DC link in a power electronic converter may also be used for adjusting the impedance of the current conductor structure. In the context of the present disclosure, the term “passive component” or “passive electric component” may be one discrete passive electric component or a plurality of discrete passive components connected in series and/or in parallel.

There are many ways to manufacturing a laminate structure for the current conductor structure according to the present disclosure. Printed circuit board manufacturing process may be used, for example. In one embodiment, the first and second electrically conducting strips may be in the form of self-adhesive tapes each folded around one or more layers of the supporting laminate structure. Manufacturing a current conductor structure with a frequency-dependent resistance may comprise folding an electrically conducting strip around a first layer of insulating material to form an inductive loop. As a result, the strip extends on one surface of the first layer, then folds at an end of the layer, and extends back on the other surface of the first layer. At least one second layer of insulating material may be attached to the first layer to form a laminate structure, and another electrically conducting strip may be folded around the laminate structure. The two electrically conducting strips may then be connected in parallel. The two electrically conducting strips may configured by using above-described principles. One of the two electrically conducting strips may have a higher resistance and a lower inductance than the other electrically conducting strip so that, at frequencies above a set frequency limit, the resistance component of a total impedance of the current conductor structure is larger than the resistance component of the impedance of said other electrically conducting strip.

It will be obvious to a person skilled in the art that, as the technology advances, the inventive concept can be implemented in various ways. The invention and its embodiments are not limited to the examples described above but may vary within the scope of the claims.

1. A current conductor structure comprising:
a first current path; and
a second current path,
wherein the first current path and the second current path are connected in parallel, and
wherein the second current path has a higher resistance and a lower inductance than the first current path such that, above a set frequency limit, a resistance component of a total impedance of the current conductor structure is larger than a resistance component of an impedance of the first current path.

2. The current conductor structure of claim 1, comprising:
one or more layers of insulating material forming a supporting laminate structure; and
a first electrically conducting strip acting as the first current path, wherein the first electrically conducting strip is arranged to form a first inductive loop that extends in a first direction parallel to a plane of the laminate structure and in a second direction perpendicular to the plane of the laminate structure.

3. The current conductor structure of claim 2, comprising:
a second electrically conducting strip acting as the second current path, wherein the second electrically conducting strip is arranged to form a second inductive loop that extends in the first direction and in the second direction,
wherein dimensions of the first inductive loop and the second inductive loop in the first direction and in the second direction define loop areas of the first inductive loop and the second inductive loop, and wherein the loop area of the first inductive loop is larger than the loop area of the second inductive loop.

4. The current conductor structure of claim 3, wherein
the second electrically conducting strip folds around one or more layers of the supporting laminate structure to form the second inductive loop, and
the first electrically conducting strip folds around at least one more layer of the supporting laminate structure than the first electrically conducting strip to form the first inductive loop.

5. The current conductor structure of claim 3, wherein the second inductive loop is arranged inside the first inductive loop.

6. The current conductor structure of claim 3, wherein the second electrically conducting strip is made from a different material than the first electrically conducting strip.

7. The current conductor structure of claim 6, wherein the first current path is made of copper foil and the second current path is made of aluminum foil.

8. The current conductor structure of claim 3, wherein the second electrically conducting strip has a different width and/or thickness than the first electrically conducting strip.

9. The current conductor structure of claim 3, wherein the first electrically conducting strip and the second electrically conducting strip are in the form of self-adhesive tapes each folded around one or more layers of the supporting laminate structure.

10. The current conductor structure of claim 1, wherein the first and/or the second current path comprises a passive electric component.

11. The current conductor structure of claim 1, comprising:
one or more layers of insulating material forming a supporting laminate structure;
a first portion and a second portion of a first electrically conducting strip, and
a first passive electric component electrically coupling the first portion and the second portion of the first electrically conducting strip together,
wherein the first portion of the first electrically conducting strip, the second portion of the first electrically conducting strip, and the first passive electric component are arranged to act as the first current path and form a first inductive loop that extends in a first direction and in a second direction.

12. The current conductor structure of claim 11, comprising:
a first portion and a second portion of a second electrically conduct strip; and
a second passive electric component electrically coupling the first portion and the second portion of the second electrically conducting strip together,
wherein the first portion of the second electrically conducting strip, the second portion of the second electrically conducting strip, and the passive electric component are arranged to act as the second current path and form a second inductive loop that extends in a first direction in a plane of the laminate structure and in a second direction perpendicular to the plane of the laminate structure.

13. A method for manufacturing a current conductor structure with a frequency-dependent resistance, the method comprising:
folding an electrically conducting strip around a first layer of insulating material to form an inductive loop,
attaching at least one second layer of insulating material to the first layer to form a laminate structure,
folding another electrically conducting strip around the laminate structure, and
connecting the two electrically conducting strips in parallel,
wherein one of the two electrically conducting strips has a higher resistance and a lower inductance than the other electrically conducting strip such that, above a set frequency limit, a resistance component of a total impedance of the current conductor structure is larger than a resistance component of an impedance of said other electrically conducting strip.
